(19) United States
(12) Patent Application Publication
(10) Pub. No.: US 2006/0049153 A1
(43) Pub. Date: Mar. 9, 2006

(54) Dual feed laser welding system

(76) Inventors: Christopher L. Cahoon, Mesa, AZ (US); Randall E. Dowding, Gilbert, AZ (US); Srikanth Sankaranarayanan, Greer, SC (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/936,894

(22) Filed: Sep. 8, 2004

(51) Int. Cl. B23K 26/20

(52) U.S. Cl. 219/121.63; 219/121.82

(57) ABSTRACT

The present invention provides an apparatus for automated laser welding repairs. The apparatus is adapted for use with components of gas turbine engines such as compressor and turbine airfoils and blisks. The apparatus comprises a dual means of providing filler material. The filler material may be provided through a wire feeder. Optionally, the filler material may be provided through a powder feeder.

### FIELD OF THE INVENTION

The present invention relates to welding. More particularly the invention relates to automated laser welding and the material feeding systems by wire and powder in automated welding systems.

### BACKGROUND OF THE INVENTION

Turbine engines are used as the primary power source for many types of aircrafts. The engines are also auxiliary power sources that drive air compressors, hydraulic pumps, and industrial gas turbine (IGT) power generation. Further, the power from turbine engines is used for stationary power supplies such as backup electrical generators for hospitals and the like.

Most turbine engines generally follow the same basic power generation procedure. Compressed air generated by axial and/or radial compressors is mixed with fuel and burned, and the expanding hot combustion gases are directed against stationary turbine vanes in the engine. The vanes turn the high velocity gas flow partially sideways to impinge on the turbine blades mounted on a rotatable turbine disk. The force of the impinging gas causes the turbine disk to spin at high speed. Jet propulsion engines use the power created by the rotating turbine disk to draw more air into the engine and the high velocity combustion gas is passed out of the gas turbine aft end to create forward thrust. Other engines use this power to turn one or more propellers, fans, electrical generators, or other devices.

In an attempt to increase the efficiencies and performance of contemporary gas turbine engines generally, engineers have progressively pushed the engine environment to more extreme operating conditions. The harsh operating conditions of high temperature and pressure that are now frequently specified place increased demands on engine component-manufacturing technologies and new materials. Indeed the gradual improvement in engine design has come about in part due to the increased strength and durability of new materials that can withstand the operating conditions present in the modern gas turbine engines. With these changes in engine materials, there has arisen a corresponding need to develop new repair methods appropriate for such materials.

Low and high pressure compressor (LPC/HPC) components such as compressor blades and impellers are primary components in the cold section for any turbine engine, and they must be well maintained. The LPC/HPC components are subjected to stress loadings during turbine engine operation, and also are impacted by foreign objects such as sand, dirt, and other such debris. The LPC/HPC components can degrade over time due to wear, erosion and foreign object damage. Sometimes LPC/HPC components are degraded to a point at which they must be repaired or replaced, which that can result in significant operating expense and time out of service.

The option of throwing out worn engine components such as turbine blades and replacing them with new ones is not an attractive alternative. The blades are extremely expensive due to costly material and manufacturing process. A high pressure turbine blade made of superalloy can be quite costly to replace, and a single stage in a gas turbine engine may contain several dozen such blades. Moreover, a typical gas turbine engine can have multiple rows or stages of turbine blades. Consequently there is a strong financial need to find an acceptable and efficient repair method for engine components.

There are several traditional methods for repairing damaged turbine engine components, and each method has some limitations in terms of success. One primary reason for the lack of success is that the materials used to make LPC/HPC components do not lend themselves to efficient repair techniques. For example, titanium alloys are commonly used to make fan and compressor blades because the alloys are strong, light weight, and highly corrosion resistant. However, repairing the compressor blade with conventional welding techniques subjects the compressor blade to high temperatures at which the welding areas are oxidation-prone.

Turbine blades used in modern gas turbine engines are frequently castings from a class of materials known as superalloys. The superalloys include nickel-based, cobalt-based and iron-based superalloys. In the cast form, turbine blades made from advanced superalloys include many desirable properties such as high elevated-temperature strength and good environment resistance. Advantageously, the strength displayed by this material remains present even under stressful conditions, such as high temperature and high pressure, experienced during engine operation. Disadvantageously, the superalloys generally are very difficult to weld successfully. Various methods have been developed and are described in the technical literature related to resurfacing, restoring, repairing, and reconditioning worn turbine blades.

A welding operation of particular relevance for repair of gas turbine engine components is laser welding. In many cases laser welding techniques provide localized and controlled heating such that welding repairs may be affected without undue stress on the remainder of the workpiece. In many cases laser welding techniques provide an acceptable repair method where a traditional welding technique does not. Thus, there is a need for methods that allow for the efficient and rapid laser welding repair of a variety of gas turbine engine components.

Laser welders can be quite expensive. It would thus be desired to make them adaptable to as many situations as possible and to as many kinds of engine components as possible. In that way the need for multiple machines, to perform repairs on different types of pieces, is minimized. In particular, it would be desired to have a single laser welding machine that can perform repairs both with powder feed and wire feed.

Hence, there is a need for a laser repair method that addresses one or more of the above-noted drawbacks and needs. Namely, a repair method is needed that can fully restore geometry, dimension and desired properties of degraded gas turbine engine components and/or a method that allows flexibility with respect to feeder methods and thus a method is desired that can effect a variety of repairs through use of a single machine. Finally, it would be desired to provide a laser welding repair method that by virtue of the foregoing is therefore less costly as compared to the alternative of replacing worn parts with new ones. The present invention addresses one or more of these needs.

### SUMMARY OF THE INVENTION

The present invention provides an apparatus and methods for use in automated welding repairs. In one embodiment, the invention provides a dual feed laser welding device. The dual feeder allows for selection of a means of providing filler material. The dual feed laser welding system includes both a powder feeder and a wire feeder.

In one embodiment, and by way of example only, there is provided a laser welding system comprising: a laser generator; a laser conveyance (which may be moveable); a first means for providing a filler material; and a second means for providing filler material. The first means for providing a filler material may comprise a powder feeder, and the second means for providing filler material may comprise a wire feeder. The laser welding system may also include a moveable work table.

In a further embodiment, still by way of example only, there is provided an automated laser welding system comprising: a laser generator capable of generating a laser beam; a moveable laser conveyance for conveying the laser beam connected to the laser generator; a video camera; a video monitor; a moveable work table; a wire feeder; a powder feeder; and a controller connected to the laser generator, laser conveyance, video camera, video monitor, work table, wire feeder, and powder feeder. The laser conveyance may include fiber optic cable. The automated laser welding system may also include an inert gas system. The powder feeder may provide a coaxial powder feed with respect to the laser beam; optionally, the powder feeder may provide an off-axis powder feed with respect to the laser beam. There may be a plurality of powder feeder nozzles.

In still a further embodiment, and still by way of example only, there is provided a method for performing an automated welding operation comprising the steps of: selecting a method of providing a filler material; digitizing a weld path; generating a laser beam; discharging a filler material; moving a laser beam and filler material over a weld path; and measuring the depth of the layer of deposited material. Filler material may be discharged through a powder feeder or wire feeder. The step of selecting a method of providing a filler material may further comprise selecting both a wire feeder and a powder feeder, and the step of discharging a filler material may further comprise discharging material through both a wire feeder and a powder feeder.

Other independent features and advantages of the dual feed automated laser welder will become apparent from the following detailed description, taken in conjunction with the accompanying drawings which illustrate, by way of example, the principles of the invention.

### BRIEF DESCRIPTION OF THE DRAWINGS

FIG. 1 is a perspective view of a laser welding system according to an embodiment of the present invention.

FIG. 2 is a perspective view of a laser beam discharged by the laser welding system according to an embodiment of the present invention.

FIG. 3 is a perspective view of a wire feeder according to an embodiment of the present invention.

FIG. 4 is a perspective view of a powder feeder according to an embodiment of the present invention.

FIG. 5 is an exemplary functional block diagram of a laser welding process according to an embodiment of the present invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention. Reference will now be made in detail to exemplary embodiments of the invention, examples of which are illustrated in the accompanying drawings. Wherever possible, the same reference numbers will be used throughout the drawings to refer to the same or like parts.

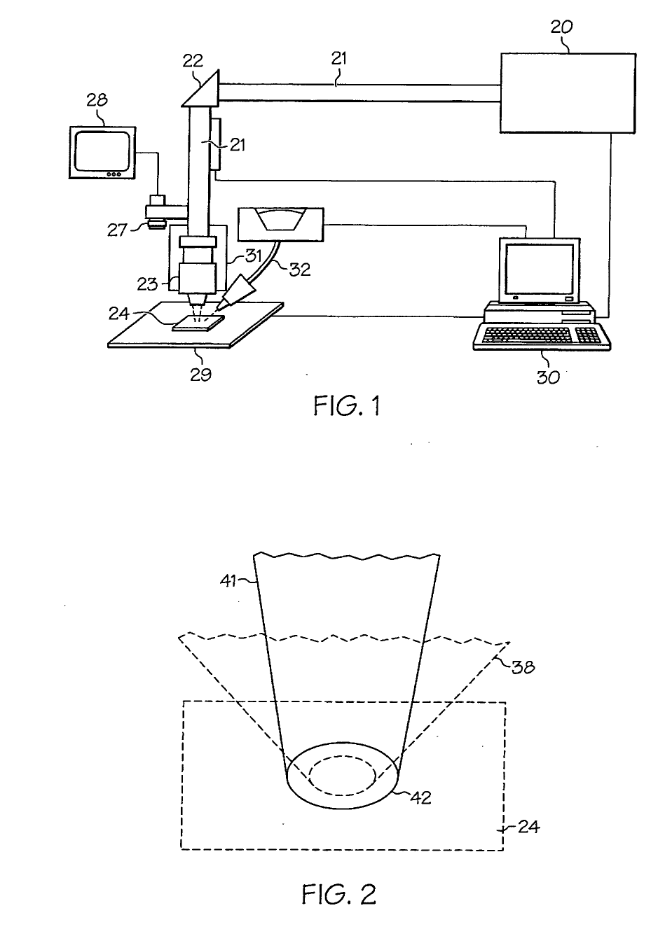

Referring now to FIG. 1 there is shown a schematic diagram of a general apparatus for laser generation and control that may be used in the dual-feed laser welding system according to an embodiment of this invention. Laser generating means 20 generates a laser used in the welding system. A laser is directed through beam guide 21, through mirror 22, and through focus lens 23. The laser then impinges on a surface of the workpiece 24. Components such as beam guide 21 mirror 22, and focus lens 23 are items known in the art of laser powder fusion welding. Collectively these items may be referred to herein as a laser conveyance. Beam guide 21 may include fiber optic materials such as fiber optic laser transmission lines.

A means for providing a filler or cladding material is also included for use with the laser-welding system. The means for providing the filler material comprises powder feeder 31 and wire feeder 32. These feeding mechanisms are described further below.

Other components that may be included in the laser-welding system include a vision CCD camera 27 and video monitor 28. The image taken by the camera can also be feedback to the controller screen 30 for positioning and welding programming. The workpiece 24 is held on a work table 29. An inert gas system may also be included in the laser welder. Through the system an inert gas shield (not shown) is fed through guides (not shown) onto the workpiece 24. The inert gas shield is directed onto a portion of the surface of the workpiece 24 during laser welding.

Controller 30 may be a computer numerically controlled (CNC) positioning system. CNC controller 30 coordinates components of the system. As is known in the art the controller may also include a digital imaging system. The controller 30 guides movement of the laser and material feed across the face of the workpiece 24. In one embodiment, movement of the workpiece in the XY plane is achieved through movement of the worktable. Movement in the up and down, or Z-direction is achieved by control of the laser arm; i.e., pulling it up or lowering it. Alternative methods of control are possible, such as controlled movement of the workpiece in all three directions, X, Y, and Z as well as rotation and tilt. In some embodiments, control of beam guide 21 provides movement in the X, Y, and Z axes, while control of the work table 29 provides movement of rotation and tilt.

The use of controller 30, camera 27, and monitor 28 in the laser-welding system may further allow for automated welding operations. In this manner automated welding routines may be performed on a workpiece without the need for manual control of the welding operation. In automated welding routines, camera 27 records digital information regarding the surface of the workpiece to be repaired. This information is then processed into a welding routine by controller 30 which in turn controls movement of the laser beam during welding.

As further shown in FIG. 2 one embodiment of the automated laser apparatus includes laser beam 41. Laser beam 41 is generated by laser generating means 20 and projected onto work piece 24 through the laser welding system. Laser beam 41 impinges on the workpiece surface as laser beam spot 42. Laser beam 41 represents the laser used to perform operations such as laser welding, cladding, and deposition. The laser-welding system disclosed herein is suitable for use with laser welding generators such as the YAG, CO₂, fiber, and direct diode lasers.

In a preferred embodiment, the power carried in the laser beam 41 is between about 50 to about 2500 wafts and more preferably between about 50 to about 1500 wafts. The powder feed rate of powder filler material is between about 1.5 to about 20 grams per minute and more preferably about 1.5 to about 10 grams per minute. Traveling speed for the motion of the substrate work table 29 relative to laser beam 41 is about 5 to about 22 inches per minute and more preferably about 5 to about 14 inches per minute. The size of spot 42 is about 0.02 to about 0.1 inches in diameter and more preferably about 0.04 to about 0.06 inches. The laser-welded bead width that results through laser beam 41 is about 0.05 to about 0.100 inches. In other embodiments, the bead width is preferably about 0.75 to about 0.100 inches in width.

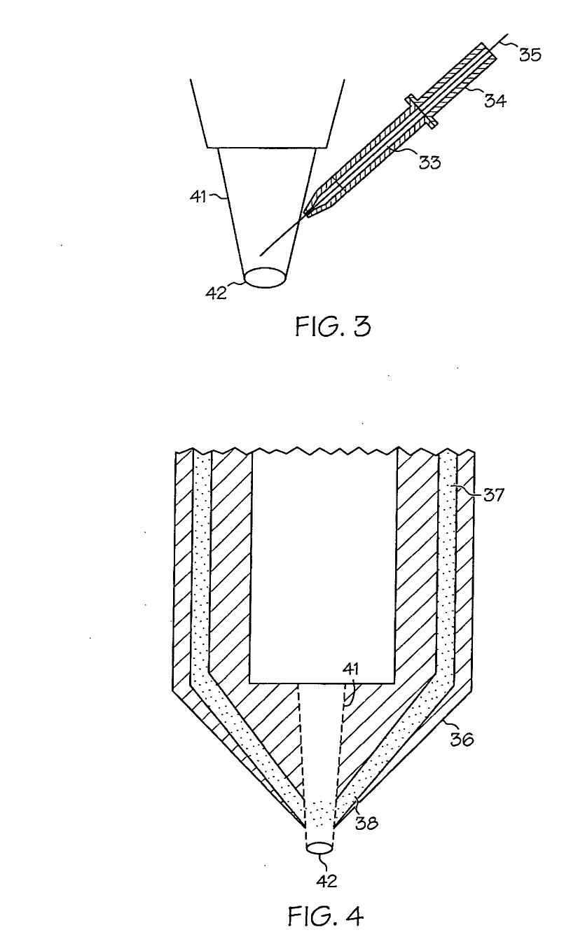

Referring now to FIG. 3 there is shown an embodiment of the invention including a wire feeder 32. In a preferred embodiment, wire feeder 32 is included in the laser welding system. Wire feeder 32 may include a wire feed nozzle 33 and tubing 34. A wire 35 is directed through tubing 34 so as to exit at wire feed nozzle 33. Rollers (not shown) can be driven by means such as an electric motor (not shown) so as to propel wire 35 through tubing 34 and wire feed nozzle 33. Wire 35 may be stored on a spool which itself is rotatably mounted to the laser apparatus.

Wire feed nozzle 33 is preferably made of a material that resists welding-related damage. A ceramic or ceramic composite are preferred materials. The wire feed nozzle also provides high heat resistance for the environment of laser welding.

In a preferred embodiment, wire feed nozzle 33 is removably affixed to the laser apparatus. Any suitable means of affixing wire feed nozzle 33 may be used such as reciprocal threading, bracaketing, or nuts and bolts. The means of affixing, however, preferably also allows the removal of wire feed nozzle 33. Thus, if a laser welding operation is to be performed that includes the welding of material to be supplied through wire 35, then wire feed nozzle 33 is attached. Conversely, if a welding operation is to be performed that does not include welding of wire material then wire feed nozzle is removed.

In one embodiment, a protective cap (not shown) can be placed over wire tubing 34 when wire feed nozzle is not in place. The protective cap may include materials that protect tubing 34 from welding-related damage.

The direction of laser beam 41 and wire feeder 32 are coordinated so that the power of laser beam 41 is used to melt wire 35. Thus in one embodiment laser beam 41 is directed such that laser beam 41 overlaps with wire 35. As wire 35 is melted, additional wire is fed through wire feeder 32. The feed rate of wire 35 is similarly coordinated with the movement of laser beam 41 over a target. Thus, the amount of material that is desired to be deposited onto a workpiece is supplied through the amount of wire 35 fed through wire feeder 32.

In one preferred embodiment, wire feeder 32 is attached to laser apparatus near focus lens 23 and proximate to the exit point of laser beam 41 from the laser apparatus. Further, the wire feeder 32 is affixed so that movement in the direction of the laser beam 41 similarly causes a movement of the wire feeder 32. Thus, wire feeder 32 and laser beam are in a permanent arrangement relative to the workpiece. Preferably, the wire feeder 32 is positioned so that wire 35 crosses the path of laser beam 41 at an angle relative to the workpiece.

In a preferred embodiment of the automated laser welding system, the laser system also includes powder feeder 31. Referring now to FIG. 4 there is shown an embodiment of the laser welding system that includes powder feeder 31. The powder feeder means includes powder nozzle 36 and powder tubing 37.

In this arrangement, powder 38, such as the powder of a preferred metal or alloy, is directed through powder nozzle 36 in the direction of the workpiece. The powder nozzle 36 directs the powder 38 in a direction that is coordinated with the direction of the laser beam. In this way the powder that is ejected through the powder nozzle 36 encounters the laser beam 41 whereupon it is melted and becomes part of the weld. A coaxial or off-axis arrangement may be used with powder feed nozzle 36 with respect to laser beam 41.

In a preferred embodiment as illustrated in FIG. 3, powder 38 is directed in a coaxial arrangement with respect to last beam 41. In this manner, powder 38 is directed from a position outside of the radius of laser beam 41, then crossing the laser beam to a position within laser beam spot 42. When the coaxial arrangement is employed, powder nozzle 36 has an annular, or semi-annular opening structure so that powder particles simultaneously are projected from all or many radial positions with respect to the laser beam.

When an off-axis arrangement is used, multiple powder nozzles may be included. In this manner, powder may be directed from powder nozzles toward the laser beam and laser beam spot from multiple directions, thus improving the welding coverage.

Powder tubing 37 provides the passage by which powder 38 may be directed to the powder nozzle 36. A flowing gas, preferably an inert gas, assists the flow of powder particles through tubing 37. Thus, as is known in the art, powder feeder 31 includes means such as motors, inert gas delivery, pumps and blowers (not shown) to direct powder 38 from a reservoir or containment device into and through tubing 37 toward powder nozzle 36. Metering devices may be used to control the rate at which powder material is fed into the laser welding system.

When powder filler material is used, powders of various sizes may be used. Preferably, the dimension of filler powder is measured by its mesh size, ranging from +45 mesh to −100 mesh (45 to 150 microns).

In one embodiment, the powder nozzle 37 is removably attached to the laser apparatus. The powder nozzle may be attached by known methods such as through the use of reciprocal threading or bolts. Attachment of powder nozzle 37 to the laser apparatus further allows the powder nozzle to be moved and directed when laser beam 41 is moved and directed. Thus, during operation, powder nozzle 37 does not need to be aimed or moved independently of the laser beam.

One laser embodiment that has been found to operate in the present welding method is known as a direct diode laser. A direct diode laser provides a compact size, good energy absorptivity, and a reasonably large beam spot size. Laser Diodes, sometimes called injection lasers, are similar to light-emitting diodes [LEDs]. In forward bias [+ on p-side], electrons are injected across the P-N junction into the semiconductor to create light. These photons are emitted in all directions from the plane on the P-N junction. To achieve lasing, mirrors for feedback and a waveguide to confine the light distribution are provided. The light emitted from them is asymmetric. The beam shape of the HPDDL system are rectangular or a line source. This beam profile does not create a “key-hole”, thus yielding a high quality welding process. Due to their high efficiency, these HPDDL are very compact and can be mounted directly on a tube mill or robot enabling high speed and high quality welding of both ferrous and nonferrous metals.

Additionally a YAG laser may also be used in an embodiment of the present invention. The YAG laser refers to an Yttrium Aluminum Garnet laser. Such lasers also may include a doping material, such as Neodymium (Nd), and such a laser is sometimes referred to as an Nd:YAG laser. The present invention may also be practiced with YAG lasers that use other dopant materials. When operated in continuous wave (CW) mode the laser provides sufficient heat at a specific spot to effect laser welding.

While embodiments of the invention may be practiced with a variety of welding equipment, the invention is particularly adapted for use with laser welding systems. Among the existing welding systems, embodiments of the invention may particularly be used with LIBURDI laser welding systems such as the LAWS 5000 automated welding system offered by Liburdi Engineering Ltd., 400 Highway 6 North, Dundas, Ontario, L9H 7K4 CANADA.

Having described the invention from a structural standpoint, a method and manner of using the invention will now be described.

The feeder apparatus of the laser system is selected. A choice can be made whether to perform a laser welding operation with a powder feed or a wire feed. Whether to use powder feed or wire feed as a supply of filler material may be affected by various considerations. The choice may be driven by factors such as the availability of wire feed or powder feed for the filler material. Additionally, the quality of the weld that may be achieved with either powder feed or wire feed may be considered as a factor in the decision. Finally, cost may also be considered as a factor, comparing the cost and efficiency of wire feed versus powder feed. Several other factors may be considered such as geometric access, user preference or even the availability of a filler material in inventory.

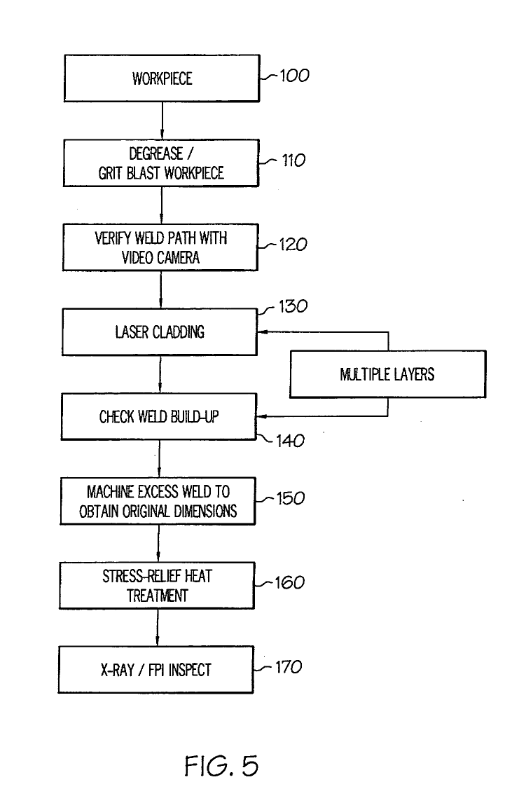

Referring now to FIG. 5, there is shown a functional block diagram of the steps in one embodiment of the laser welding process. A suitable workpiece is first identified in step 100. Inspection of the workpiece confirms that the workpiece is a suitable candidate for operation by a laser welding process. The workpiece should not suffer from mechanical defects or other damage that would disqualify it from return to service, other than wear, which can be repaired by the welding method.

Step 110 reflects that the workpiece may be subjected to a pre-welding treatment to prepare the piece for welding. In a preferred embodiment the piece receives a pre-welding degreasing in order to remove materials that interfere with laser welding such as corrosion, impurity buildups, and contamination on the face of the workpiece. In addition the piece may receive a grit blasting with an abrasive such as aluminum oxide in order to enhance the absorptivity of laser beam energy.

Next, in step 120 a digital monitoring system such as used by a CNC controller may be used to identify a weld path on the workpiece. Using digital imaging through a video camera, the CNC controller records surface and dimensional data from the workpiece. Other welding parameters such as weld path geometry, distances, velocities, powder feed rates, and power outputs are entered. In addition a stitch path to cover a desired area of the turbine blade may be selected.

After these preparatory steps, laser welding deposition commences in step 130. A first deposition pass takes place. Then a series of material deposition steps are repeated, if necessary, through repetitions of steps 130 and 140. In the first pass, the laser welding process deposits a layer of filler material on the surface of the workpiece. Upon conclusion of a first welding pass, the CNC controller may check the thickness of the weld deposit, step 140. If the build-up of material is below that desired, a second welding pass occurs. While a single welding pass may not be sufficient to deposit the desired thickness of material, it is also the case that multiple passes may be needed to achieve the desired dimension of newly deposited material. In this manner a series of welding passes can build up a desired thickness of newly deposited filler material. When the digital viewer determines that the thickness of material has reached the desired limit, welding ceases.

In step 150 the workpiece is optionally machined to return the blade to a desired configuration or dimension. The deposition of the filler may result in an uneven surface. Machining restores an even surface to a desired dimension. Similarly it may be desirable to overdeposit material in order to assure that sufficient coating layer remains on the surface. Known machining techniques can then remove excess weld material.

Post welding steps may also include procedures such as a heat treatment to achieve stress relief, step 160. An FPI (Fluorescent Penetration Inspection) inspection of the workpiece, as well as an x-ray inspection, step 170, may follow. At this time the workpiece may be returned to service, or placed in service for the first time.

Multiple passes may be used to build up required dimension of material where one pass overlaps a previous pass and successive passes are laid atop a previous pass. Similarly, the method allows for cladding of an area greater than that covered in a single pass by laying successive passes alongside previous passes thus covering a desired area. If needed, repetitions of the laser welding passes can be done in order to achieve a required level of buildup and/or coverage over a required area. Upon conclusion of a first pass the CNC controller can check the thickness of the weld deposit.

In a preferred manner of usage, the laser welding system operates with either a powder feeder or a wire feeder. In other words, one system or the other is chosen for a given welding operation. However, it is acceptable to perform laser welding with the system while actively using both the powder feeder and wire feeder as a means of discharging filler material.

While the laser welding repair operation may be adapted to many kinds of workpieces, it is designed and intended for particular application to dimensional restoring of gas turbine components such as impeller or turbine blades, blisks, and vanes. This includes repairs to the blade tip, platform, z-notch, and leading/trailing edge repair. The repairs include resurfacing and restoration of dimensional requirements to worn surfaces. Oil pressure tube dimensional restorations may also be achieved with the disclosed method and apparatus.

Further, a preferred embodiment of operation relates to the deposition or cladding of a metal or alloy material on the work surface where the deposited metal or alloy material matches the composition of the workpiece metal or alloy. The objective in such an operation is to build up the worn area on the workpiece.

The powder or wire filler used in the laser welding process is preferably compatible with the material comprising the workpiece; preferably the powder or wire filler is the same material that was used to fabricate the workpiece.

Some superalloy filler materials that are suitable for the practice of this invention and that are commercially available in powder and wire form include: HS188, Stellite 694, Hastelloy X, INCO 713, INCO 738, INCO 939, MarM247, Rene 80, C 101. Some matrix or base superalloys, which are suitable for the practice of this invention and may be laser welded include: INCO738, C101, MarM-247, Rene80, GTD111, Rene125, Rene142, SC 180, Rene N5 and N6, CMSX-2, CMSX4 and CMSX-10, and PWA 1480 and 1484.

A first advantage that may be realized through the use of the dual feed laser welding system is the improved flexibility in welding operations that may be performed with a single laser welder. Now a single welding machine may perform welding operations regardless of the kind of feeding system or filler material that is desired.

An additional advantage that may be realized through the use of the dual feed laser welding system is cost savings. Now a single machine can be used to perform operations that used to require multiple machines. Additionally, cost savings may be realized through inventory management in that both wire and powder filler inventories may be consumed or minimized.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A laser welding system comprising:
a laser generator;
a laser conveyance;
a first means for providing a filler material; and
a second means for providing filler material.

2. The laser welding system according to claim 1 wherein the first means for providing a filler material comprises a powder feeder.

3. The laser welding system according to claim 1 wherein the second means for providing filler material comprises a wire feeder.

4. The laser welding system according to claim 1 further comprising a moveable work table.

5. The laser welding system according to claim 1 wherein the laser conveyance is moveable.

6. The laser welding system according to claim 1 wherein the laser generator comprises a YAG laser.

7. The laser welding system according to claim 1 wherein the laser generator comprises a direct diode laser.

8. An automated laser welding system comprising:
a laser generator capable of generating a laser beam;
a moveable laser conveyance for conveying the laser beam connected to the laser generator;
a video camera;
a video monitor;
a moveable work table;
a wire feeder;
a powder feeder; and
a controller connected to the laser generator, laser conveyance, video camera, video monitor, work table, wire feeder, and powder feeder.

9. The automated laser welding system according to claim 8 wherein the laser generator comprises a YAG laser.

10. The automated laser welding system according to claim 8 wherein the laser generator comprises a direct diode laser.

11. The automated laser welding system according to claim 8 wherein the laser generator comprises a CO₂ laser.

12. The automated laser welding system according to claim 8 wherein the laser conveyance comprises fiber optic cable.

13. The automated laser welding system according to claim 8 further comprising an inert gas system.

14. The automated laser welding system according to claim 8 wherein the powder feeder provides a coaxial powder feed with respect to the laser beam.

15. The automated laser welding system according to claim 8 wherein the powder feeder provides an off-asix powder feed with respect to the laser beam.

16. The automated laser welding system according to claim 15 further comprising a plurality of powder feeder nozzles.

17. The automated laser welding system according to claim 8 wherein the wire feeder finer comprises a wire feeder nozzle removably affixed to the laser conveyance.

18. A method for performing an automated welding operation comprising the steps of:
selecting a method of providing a filler material;
digitizing a weld path;
generating a laser beam;
discharging a filler material;
moving a laser beam and filler material over a weld path; and
measuring the depth of the layer of deposited material.

19. The method according to claim 18 further comprising discharging filler material through a powder feeder.

20. The method according to claim 18 further comprising discharging filler material through a wire feeder.

21. The method according to claim 18 fiber comprising the step of machining a wear surface of a workpiece.

22. The method according to claim 18 further comprising the step of grit blasting a wear surface of a workpiece.

23. The method according to claim 18 wherein the step of discharging a filler material farther comprises discharging a powder with mesh size between 45 and 100 mesh.

24. The method according to claim 18 wherein the step of generating a laser further comprises generating a laser with power between about 50 and about 2500 watts.

25. The method according to claim 18 wherein the step of moving a laser beam further comprises moving a laser beam relative to a work piece at a rate of between about 5 to about 22 inches per minute.

26. The method according to claim 18 wherein the step of selecting a method of providing a filler material further comprises selecting both a wire feeder and a powder feeder and wherein the step of discharging a filler material further comprises discharging material through both a wire feeder and a powder feeder.
